(19) United States
(12) Patent Application Publication
(10) Pub. No.: US 2021/0310644 A1
(43) Pub. Date: Oct. 7, 2021

(54) FOLDING LAMP

(71) Applicant: DONGGUAN OSM DIGITAL CO., LTD, DONGGUAN (CN)

(72) Inventor: MEIHUA XIA, SHENZHEN (CN)

(21) Appl. No.: 16/924,140

(22) Filed: Jul. 8, 2020

(30) Foreign Application Priority Data
Apr. 3, 2020 (CN) 202020487496.0

(51) Int. Cl. F21V 21/30; F21V 3/00

(52) U.S. Cl. CPC F21V 21/30; F21V 3/00

(57) ABSTRACT

The present disclosure provides a folding lamp. The folding lamp includes a main body, a rotating assembly, and a side light-emitting assembly. The rotating assembly is rotatably connected with the main body. The side light-emitting assembly is rotatably connected with the rotating assembly. The side light-emitting assembly is openable from the main body or foldable up on the main body by rotating the side light-emitting assembly or the rotating assembly.

### TECHNICAL FIELD

The present disclosure relates to a field of lighting equipment, in particular to a folding lamp.

### BACKGROUND

There are a variety of lamps for lighting on the market. In the beginning, the lamps were simple lamps and for lighting. But with development of society, lamps are used in various occasions to meet various needs.

At present, there are many kinds of lamps on the market, and they are divided into different categories according to different uses. However, most of the lamps on the market are so single-purpose and have a small lighting range, which are inconvenient to store and unable to meet various usage scenarios and requirements of consumers.

### SUMMARY

An object of the present disclosure is to provide a folding multi-purpose lamp with a large lighting range, and is convenient to store.

The present disclosure provides a folding lamp. The folding lamp comprises a main body, a rotating assembly, and a side light-emitting assembly. The rotating assembly is rotatably connected with the main body. The side light-emitting assembly is rotatably connected with the rotating assembly. The side light-emitting assembly is openable from the main body or foldable up on the main body by rotating the side light-emitting assembly or the rotating assembly.

In one embodiment, the rotating assembly is arranged on a top portion of the main body.

In one embodiment, the rotating assembly comprises a bottom cover and a top cover. The bottom cover is rotatably connected with the side light-emitting assembly and the main body respectively. The bottom cover is covered with the top cover.

In one embodiment, the side light-emitting assembly comprises a first side light-emitting assembly and a second side light-emitting assembly. The first side light-emitting assembly and the second side light-emitting assembly are, respectively, rotatably connected with the rotating assembly.

In one embodiment, both of the first side light-emitting assembly and the second side light-emitting assembly comprise a mounting seat and a light-emitting lamp panel providing a light source. Each mounting seat is rotatably connected with the rotating assembly. Each light-emitting lamp panel is arranged on a first outer side of each mounting seat.

In one embodiment, both of the first side light-emitting assembly and the second side light-emitting assembly comprise a mounting seat and a light-emitting lamp panel providing a light source. Each mounting seat is rotatably connected with the rotating assembly. Each light-emitting lamp panel is arranged on a first inner side of each mounting seat.

In one embodiment, both of the first side light-emitting assembly and the second side light-emitting assembly comprise a first lampshade protecting the light-emitting lamp panel and a second lampshade softening the light. Each first lampshade covers each light-emitting lamp panel. Each second lampshade covers each first lampshade.

In one embodiment, the side light-emitting assembly comprises a front light-emitting assembly. The front light-emitting assembly is arranged on a second outer side of the main body.

In one embodiment, the side light-emitting assembly comprises a front light-emitting assembly. The front light-emitting assembly is arranged on a second inner side of the main body.

In one embodiment, the side light-emitting assembly rotates in a range of 0-90 degrees with respect to the rotating assembly. The rotating assembly rotates in a range of 0-180 degrees with respect to the main body.

In the present disclosure, the side light-emitting assembly 300 is foldable on the main body 100 and is openable from the main body 100 by rotating the side light-emitting assembly 300 and rotating the rotating assembly 200 relative to the main body 100 to achieve folding of the folding lamp and multi-angle rotating lighting. Further, the folding lamp has a large lighting range, is convenient to store, and is able to achieve multi-purpose lighting. For example, the folding lamp is able to be used as a fill light for selfie sticks, table lamps, general self-use illumination lamps, etc.

### BRIEF DESCRIPTION OF DRAWINGS

The drawings are included to provide a further understanding of embodiments of the present disclosure, which form portions of the specification and are used to illustrate implementation manners of the present disclosure and are intended to illustrate operating principles of the present disclosure together with the description. Apparently, the drawings in the following description are merely some of the embodiments of the present disclosure, and those skilled in the art are able to obtain other drawings according to the drawings without contributing any inventive labor. In the drawing:

FIG. 1 is a schematic diagram of a folding lamp according to one embodiment of the present disclosure.

FIG. 2 is another schematic diagram of the folding lamp according to one embodiment of the present disclosure.

FIG. 3 is another schematic diagram of the folding lamp according to one embodiment of the present disclosure.

FIG. 4 is a schematic diagram of the folding lamp according to one embodiment of the present disclosure where the folding lamp is in an open state.

FIG. 5 is a partial exploded schematic diagram of the folding lamp according to one embodiment of the present disclosure.

FIG. 6 is a cross-sectional view taken along the direction A-A shown in FIG. 2.

FIG. 7 is another schematic diagram of the folding lamp according to one embodiment of the present disclosure where the folding lamp is in another open state.

FIG. 8 is another schematic diagram of the folding lamp according to one embodiment of the present disclosure where the folding lamp is in another open state.

FIG. 9 is another schematic diagram of the folding lamp according to one embodiment of the present disclosure where the folding lamp is in another open state.

FIG. 10 is a schematic diagram of a screw hole according to one embodiment of the present disclosure.

FIG. 11 is another schematic diagram of the folding lamp according to one embodiment of the present disclosure.

FIG. 12 is another schematic diagram of the folding lamp according to one embodiment of the present disclosure where the folding lamp is in another open state.

FIG. 13 is another schematic diagram of the folding lamp according to one embodiment of the present disclosure where the folding lamp is in another open state.

FIG. 14 is another schematic diagram of the folding lamp according to one embodiment of the present disclosure where the folding lamp is in another open state.

FIG. 15 is another schematic diagram of the folding lamp according to one embodiment of the present disclosure where the folding lamp is in another open state.

In the drawings:

100: main body; 110 second outer side; 120: second inner side; 200: rotating assembly; 210: bottom cover; 220: top cover; 300: side light-emitting assembly; 310: first side light-emitting assembly; 311: mounting seat; 311a: first outer side; 311b: first inner side; 312: light-emitting lamp panel; 312a: PCB; 312b: lamp beads; 313: first lampshade; 314: second lampshade; 315: decorative ring; 320: second side light-emitting assembly; 400: front light-emitting assembly; 500: battery; 600: charging interface; 700: switch button; 800: brightness adjusting button; and 900: screw hole.

### DETAILED DESCRIPTION

Specific structure and function details disclosed herein are only representative and are used for the purpose of describing exemplary embodiments of the present disclosure. However, the present disclosure may be achieved in many alternative forms and shall not be interpreted to be only limited to the embodiments described herein.

It should be understood in the description of the present disclosure that terms such as “first” and “second” are only used for the purpose of description, rather than being understood to indicate or imply relative importance or hint the number of indicated technical features. Thus, the feature limited by “first” and “second” can explicitly or impliedly comprise one or more features. In the description of the present disclosure, the meaning of “a plurality of” is two or more unless otherwise specified. In addition, the term “comprise” and any variant are intended to cover non-exclusive inclusion, one or more other features, integers, steps, operations, units, components, and/or combinations thereof may be present or added.

In addition, terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present disclosure and the simplification of the description rather than to indicate or imply that the indicated device or element must have a specific direction or constructed and operated in a specific direction, and therefore, shall not be understood as a limitation to the present disclosure.

It should be noted in the description of the present disclosure that, unless otherwise regulated and defined, terms such as “installation,” “bonded,” and “bonding” shall be understood in broad sense, and for example, may refer to fixed bonding or detachable bonding or integral bonding; may refer to mechanical bonding or electrical bonding; and may refer to direct bonding or indirect bonding through an intermediate medium or inner communication of two elements. For those of ordinary skill in the art, the meanings of the above terms in the present disclosure may be understood according to concrete conditions.

The present disclosure will be described in detail below with reference to the drawings and optional embodiments.

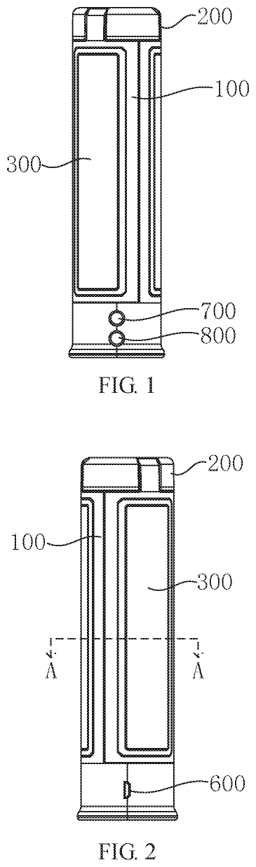

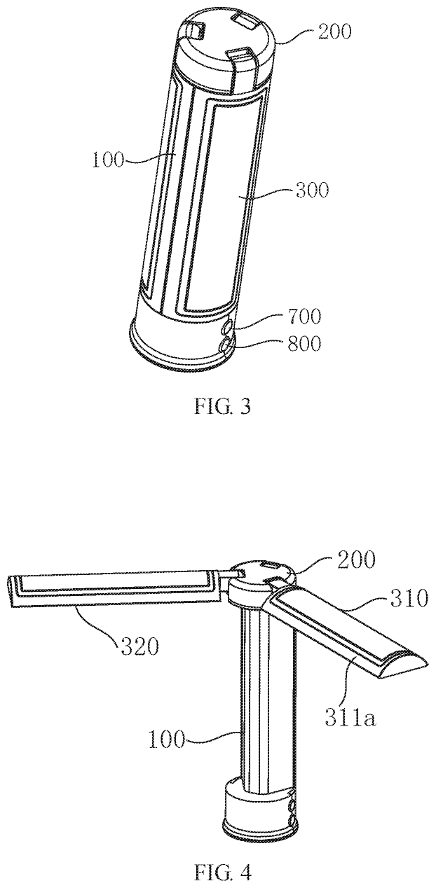

As shown in FIGS. 1-4, in one embodiment, the present disclosure provides a folding lamp. The folding lamp comprises a main body 100, a rotating assembly 200, and a side light-emitting assembly 300. The rotating assembly 200 is rotatably connected with the main body 100. The side light-emitting assembly 300 is rotatably connected with the rotating assembly 200. The side light-emitting assembly 300 is openable from the main body 100 or foldable up on the main body 100 by rotating the side light-emitting assembly 300 or the rotating assembly 200.

In the present disclosure, the side light-emitting assembly 300 is foldable on the main body 100 and is openable from the main body 100 by rotating the side light-emitting assembly 300 and rotating the rotating assembly 200 relative to the main body 100 to achieve folding of the folding lamp and multi-angle rotating lighting. Further, the folding lamp has a large lighting range, is convenient to store, and is able to achieve multi-purpose lighting. For example, the folding lamp is able to be used as a fill light for selfie sticks, a table lamp, a general self-use illumination lamp, etc.

The side light-emitting assembly 300 and the rotating assembly 200 are rotatably connected and are rotated at multiple angles. The rotating assembly 200 is rotatably connected with the main body 100 in multiple angles.

As shown in FIG. 4, specifically, the side light-emitting assembly 300 comprises a first side light-emitting assembly 310 and a second side light-emitting assembly 320. The first side light-emitting assembly 310 and the second side light-emitting assembly 320 are, respectively, rotatably connected with the rotating assembly 200. The first side light-emitting assembly 310 and the second side light-emitting assembly 320 are foldable on the main body 100 and are openable from the main body 100 by rotating the first side light-emitting assembly 310 and the second side light-emitting assembly 320 and the rotating assembly 200 to achieve folding of the folding lamp and multi-angle rotating lighting. The side light-emitting assembly 300 comprises the first side light-emitting assembly 310 and a second side light-emitting assembly 320, which increases a lighting area of the folding lamp. Of course, the side light-emitting assembly 300 may comprise a third side light-emitting assembly, a fourth side light-emitting assembly, a fifth side light-emitting assembly, etc., respectively, rotatably connected with the rotating assembly 200, the number of which is not limited thereto.

In one embodiment, the rotating assembly 200 is arranged on a top portion of the main body 100, which is convenient for the rotating assembly 200 and the side light-emitting assembly 300 to rotate, and is also convenient for lighting.

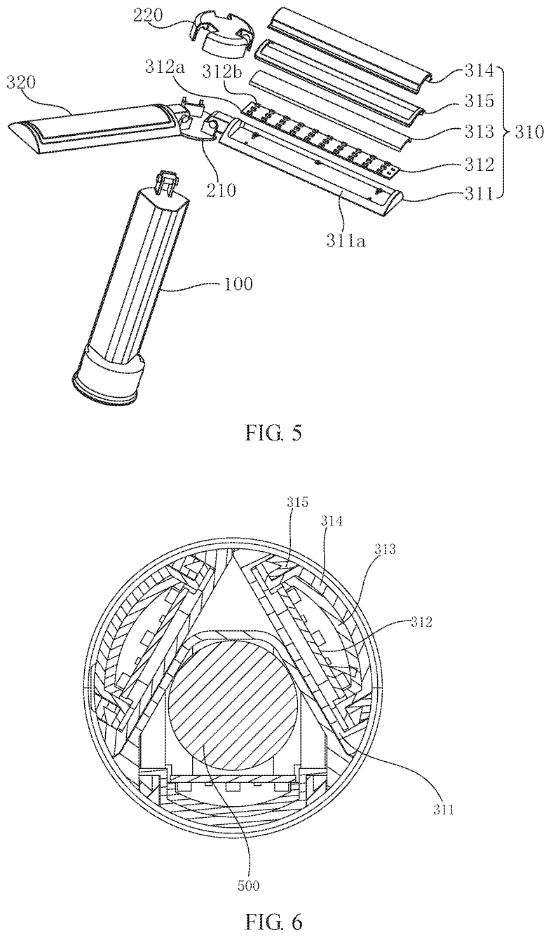

Specifically, as shown in FIGS. 5-6, both of the first side light-emitting assembly 310 and the second side light-emitting assembly 320 comprise a mounting seat 311 and a light-emitting lamp panel 312 providing a light source. Each mounting seat 311 is rotatably connected with the rotating assembly 200. Each light-emitting lamp panel 312 is arranged on a first outer side 311a of each mounting seat 311. When the first side light-emitting assembly 310 and the second side light-emitting assembly 320 are in a folded state, the side light-emitting assembly 300 may also be turned on for lighting. Specifically, each light-emitting lamp panel 312 includes a printed circuit board (PCB) 312a and lamp beads 312b arranged on the PCB 312a.

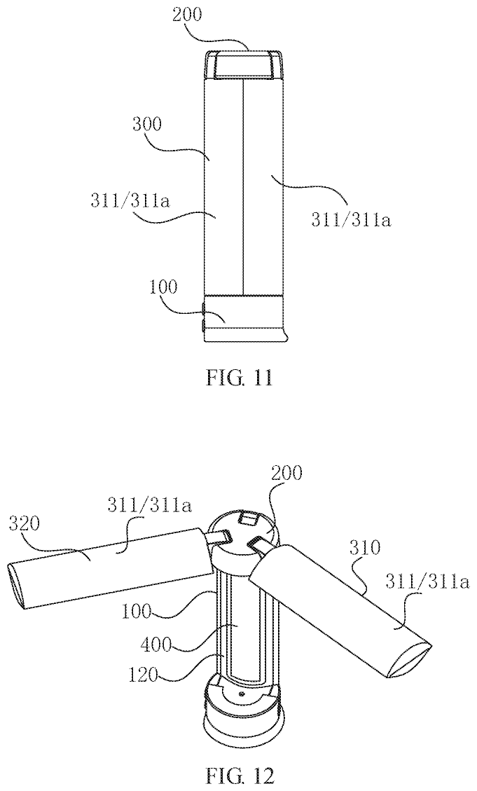

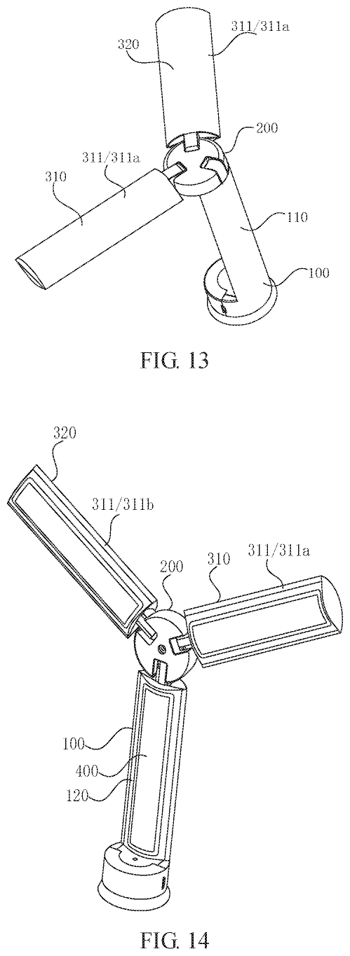

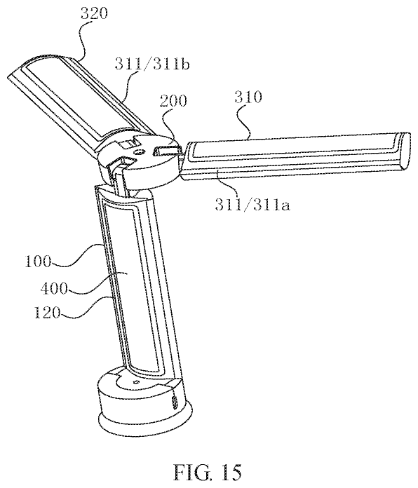

In addition, as shown in FIGS. 11-15, in one embodiment, each light-emitting lamp panel 312 is arranged on a first inner side 311b of each mounting seat 311. The first side light-emitting assembly and the second side light-emitting assembly protect the light-emitting lamp panels 312 when they are fully folded. The first side light-emitting assembly and the second side light-emitting assembly are not easy to get dust, so that the lighting of the folding lamp is not affected.

It should be noted that, as shown in FIGS. 4-5 or FIGS. 11-15, the first outer sides 311a of mounting seats 311 are one side of the first side light-emitting assembly 310 and one side of the second side light-emitting assembly 320 that exposed to an outside when the first side light-emitting assembly 310 and the second side light-emitting assembly 320 are in the folded state. As shown in FIGS. 11-15, the first inner sides 311b of the mounting seats 311 are another side of the first side light-emitting assembly 310 and another side of the second side light-emitting assembly 320 that arranged inside and do not exposed to the outside when the first side light-emitting assembly and the second side light-emitting assembly are in the folded state.

In one embodiment, both of the first side light-emitting assembly 310 and the second side light-emitting assembly 320 comprise a first lampshade 313 protecting the light-emitting lamp panel 312 and a second lampshade 314 softening the light. Each first lampshade 313 covers each light-emitting lamp panel 312. Each second lampshade 314 covers each first lampshade 313. Each first lampshade 313 protects the corresponding light-emitting lamp panel 312, and each second lampshade 314 makes the light of the corresponding light-emitting lamp panel 312 softer and more comfortable to use. In one embodiment, each second lampshade 314 is engraved to make the light diffusely reflected and therefore the light is soft.

Both of the first side light-emitting assembly 310 and the second side light-emitting assembly 320 include a decorating ring 315 for decoration. The decorative ring 315 is arranged around a periphery of the corresponding second lampshade 314. The decorative rings 315 play a decorative role and make a whole of the folding lamp more beautiful. Specifically, the decorative rings 315 may be set in various eye-catching colors, or various patterns may be printed on surfaces of the decorative rings 315.

In one embodiment, the side light-emitting assembly 300 comprises a front light-emitting assembly 400. The front light-emitting assembly 400 is arranged on a second outer side 110 of the main body 100.

In addition, as shown in FIG. 11-15, in one embodiment, the front light-emitting assembly 400 is arranged on a second inner side 120 of the main body 100. The front light-emitting assembly 400 is shielded by the first side light-emitting assembly 310 and the second side light-emitting assembly 320 when the first side light-emitting assembly 310 and the second side light-emitting assembly 320 are fully folded, so that light-emitting lamp panel 312 and other components of the front light-emitting assembly 400 are protected and the front light-emitting assembly 400 is not easy to get dust, and the lighting is not affected.

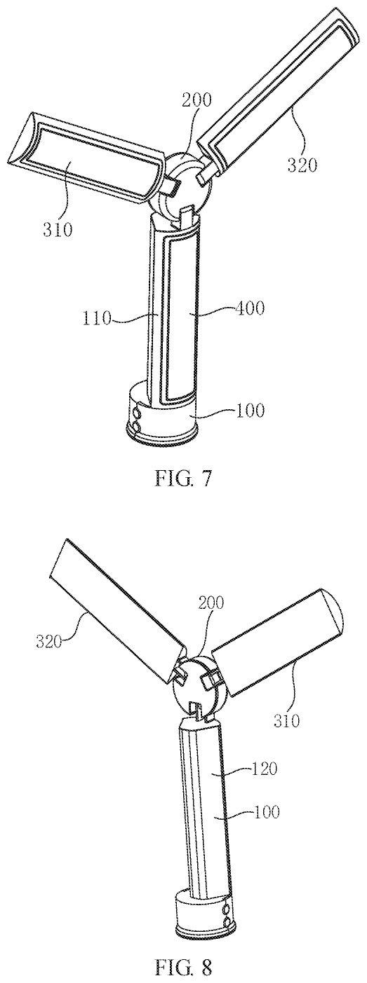

It should be noted that, as shown in FIG. 7 or FIGS. 11-15, the second outer sides 110 of the main body is one side of the main body 100 that exposed to the outside when the first side light-emitting assembly and the second side light-emitting assembly are in the folded state. As shown in FIG. 8 or FIGS. 11-15, the second inner sides 120 of the main body 100 are another side of the main body 100 that does not expose to the outside when the first side light-emitting assembly and the second side light-emitting assembly are in the folded state.

Similarly, the front light-emitting assembly 400 comprises the light-emitting lamp panel 312, the first lampshade 313 protecting the light-emitting lamp panel 312, the second lampshade 314 softening the light, and the decorating ring 315 for decoration. The light-emitting lamp panel 312 of the front light-emitting assembly 400 is arranged on the second outer sides 110 of the main body 100. The first lampshade 313 of the front light-emitting assembly 400 covers the light-emitting lamp panel 312 of the front light-emitting assembly 400. The second lampshade 314 of the front light-emitting assembly 400 covers the first lampshade 313 of the front light-emitting assembly 400. The decorative ring 315 of the front light-emitting assembly 400 is arranged around a periphery of the second lampshade 314 of the front light-emitting assembly 400. The first lampshade 313 of the front light-emitting assembly 400 protects the light-emitting lamp panel 312 of the front light-emitting assembly 400, and the second lampshade 314 of the front light-emitting assembly 400 makes the light of the light-emitting lamp panel 312 of the front light-emitting assembly 400 softer and more comfortable to use. In one embodiment, the second lampshade 314 of the front light-emitting assembly 400 is engraved to make the light diffusely reflected and therefore the light is soft. The decorative ring 315 of the front light-emitting assembly 400 plays a decorative role and makes the whole of the folding lamp more beautiful. Specifically, the decorative ring 315 of the front light-emitting assembly 400 may be set in various eye-catching colors, or various patterns may be printed on surfaces of the decorative ring 315.

In one embodiment, the side light-emitting assembly 300 rotates in a range of 0-90 degrees with respect to the rotating assembly 200. As shown in FIG. 4, the side light-emitting assembly 300 is openable from the main body 100 to achieve multi-angle lighting. The rotating assembly 200 rotates in a range of 0-180 degrees with respect to the main body 100. As shown in FIG. 1, when the first side light-emitting assembly 310 and the second side light-emitting assembly 320 are in the folded state, the folding lamp is used as a desk lamp or a general lighting equipment,

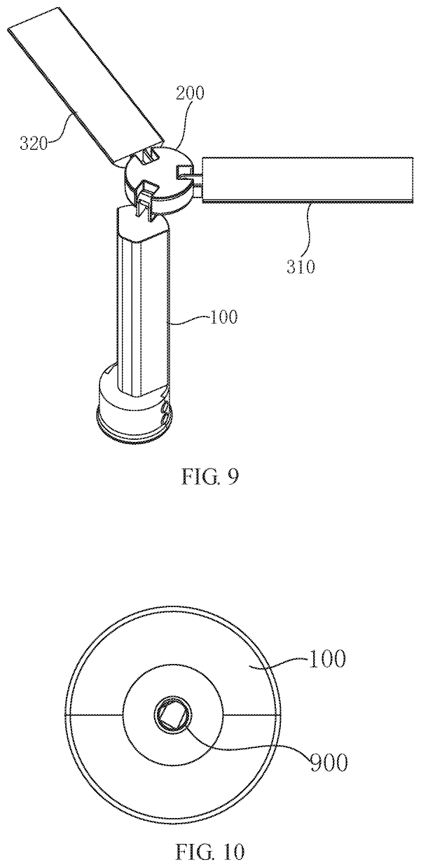

As shown in FIGS. 7-8, after the side light-emitting assembly 300 is opened from 0-90° on the main body 100, the rotating assembly 200 is further rotated 0-90°, at this time, the first side light-emitting assembly 310, the second side light-emitting assembly 320, and the front light-emitting assembly 400 are in a same plane, so that the folding lamp can be used as a fill light, As shown in FIG. 9, after the side light-emitting assembly 300 is opened from 0-90° on the main body 100, the rotating assembly 200 is further rotated from 0-180° to be used as a desk lamp.

In one embodiment, as shown in FIG. 5, the rotating assembly 200 comprises a bottom cover 210 and a top cover 220. The bottom cover 210 is rotatably connected with the side light-emitting assembly 300 and the main body 100 respectively. The bottom cover 210 is covered with the top cover 220.

As shown in FIGS. 1, 2, and 6, in one embodiment, the folding lamp further comprises a battery 500, a charging interface 600, a switch button 700, and a brightness adjusting button 800. The battery 500 supplies power for the folding lamp. The battery 500 is charged via the charging interface 600. The switch button 700 is configured to turn on or turn off the power of the folding lamp. The brightness adjusting button 800 is configure to adjust brightness of the folding lamp. Specifically, the battery 500 is arranged inside the main body 100. The charging interface 600, the switch button 700, and the brightness adjusting button 800 are arranged on a lower portion of the main body 100. As shown in FIG. 10, a screw hole 900 is arranged on a bottom portion of the main body 100 for connecting with a selfie stick, and at this time, the folding lamp is used as a fill light when taking a selfie.

The above content is further detailed descriptions of the present disclosure in conjunction with specific optional embodiments, and it should be understood that the specific implementation of the present disclosure is not limited to these descriptions. For a person of ordinary skill in the art, to which this application belongs, without deviating from the concept of the present disclosure, several simple deductions or replacements can be made, all of which should be considered as falling within the protection scope of the present disclosure.

1. A folding table lamp convenient to store comprising:
a main body;
a rotating assembly rotatably connected with the main body; and
a side light-emitting assembly rotatably connected with the rotating assembly;
wherein the side light-emitting assembly is openable from the main body or foldable up on the main body by rotating the side light-emitting assembly or the rotating assembly, wherein the side light-emitting assembly comprises a first side light-emitting assembly and a second side light-emitting assembly; the first side light-emitting assembly and the second side light-emitting assembly are, respectively, rotatably connected with the rotating assembly, wherein folding lamp comprises a front light-emitting assembly, wherein the front light-emitting assembly is arranged on a second outer/inner side surface of the main body by directly contacting thereto;
wherein the rotating assembly is arranged on a top portion of the main body.

2. (canceled)

3. The folding table lamp convenient to store according to claim 1, wherein the rotating assembly comprises a bottom cover and a top cover; the bottom cover is rotatably connected with the side light-emitting assembly and the main body respectively, the bottom cover is covered with the top cover.

4. (canceled)

5. The folding table lamp convenient to store according to claim 1, wherein both of the first side light-emitting assembly and the second side light-emitting assembly comprise a mounting seat and a light-emitting lamp panel providing a light source; each mounting seat is rotatably connected with the rotating assembly; each light-emitting lamp panel is arranged on a first outer side of each mounting seat.

6. The folding table lamp convenient to store according to claim 1, wherein both of the first side light-emitting assembly and the second side light-emitting assembly comprise a mounting seat and a light-emitting lamp panel providing a light source; each mounting seat is rotatably connected with the rotating assembly; each light-emitting lamp panel is arranged on a first inner side of each mounting seat.

7. The folding table lamp convenient to store according to claim 5, wherein both of the first side light-emitting assembly and the second side light-emitting assembly comprise a first lampshade protecting the light-emitting lamp panel and a second lampshade softening the light; each first lampshade covers each light-emitting lamp panel, each second lampshade covers each first lampshade.

8-9. (canceled)

10. The folding table lamp convenient to store according to claim 1, wherein the side light-emitting assembly rotates in a range of 0-90 degrees with respect to the rotating assembly; and the rotating assembly rotates in a range of 0-180 degrees with respect to the main body.

11. The folding table lamp convenient to store according to claim 1, the front light-emitting assembly is arranged below the first side light-emitting assembly and the second side light-emitting assembly.
